(19) United States
(12) Patent Application Publication
(10) Pub. No.: US 2023/0257119 A1
(43) Pub. Date: Aug. 17, 2023

(54) USE OF FORWARD CLOSET IN SINGLE AISLE AIRCRAFT FOR WHEELCHAIR ACCOMMODATION

(71) Applicant: B/E Aerospace, Inc., Winston-Salem, NC (US)

(72) Inventors: Glenn A. Johnson, Rural Hall, NC (US); Ann Tucker, Belews Creek, NC (US); Ankit Gupta, Wichita, KS (US); Carlos Gatti, Wichita, KS (US); Luis Gomez, Andover, KS (US)

(21) Appl. No.: 18/108,151

(22) Filed: Feb. 10, 2023

Related U.S. Application Data
(60) Provisional application No. 63/310,422, filed on Feb. 15, 2022.

(51) Int. Cl. B64D 11/00

(52) U.S. Cl. CPC B64D 11/003

(57) ABSTRACT

A passenger cabin layout including a closet and a closet positionable in a cabin such as an aircraft passenger cabin. The closet includes a first compartment for accommodating a wheelchair, such as an occupied wheelchair, in an unfolded condition, wherein the first compartment is enterable from an aisle in the cabin, such as a branch aisle extending from a door of the aircraft. The closet further includes a second compartment for storing items. In some embodiments, the first compartment is further enterable from a second branch aisle forward of at least one passenger seat, such as a seat row facing the closet. The first compartment is configured to accommodate a personal wheelchair and in some embodiments includes a floor pallet for securing the wheelchair in place in atop the pallet.

### RELATED APPLICATION AND INCORPORATION BY REFERENCE

This U.S. nonprovisional patent application claims the benefit of priority of U.S. Provisional Pat. Application No. 63/310,422 filed Feb. 15, 2022 entitled “USE OF FORWARD CLOSET IN SINGLE AISLE AIRCRAFT FOR WHEELCHAIR ACCOMMODATION,” the entirety of which is incorporated by reference.

### TECHNICAL FIELD AND BACKGROUND

The present disclosure relates generally to wheelchair accommodations for an aircraft, and more particularly, to use of a portion of a closet for accommodating an occupied wheelchair in a space-saving configuration that considers the needs and wants of wheelchair-dependent passengers as well as efficiencies in embarking and disembarking passengers.

Passengers with restricted mobility may require the use of a wheelchair. In some cases, a less severely restricted mobility passenger may be able to walk a short distance to embark and disembark an aircraft. In other cases, a severely restricted mobility passenger may be wheelchair-dependent requiring full-time use of a personal and specialized wheelchair.

Most aisle widths in aircraft are incapable of accommodating personal and specialized wheelchairs. As such, transfer chairs may be utilized supplied by the airline carrier or airport. Transfer chairs have a narrow width to be able to traverse a narrow aisle, and in some cases are used to transfer a passenger from their personal wheelchair outside the aircraft to a passenger seat on-board the aircraft. Wheelchair transfers can be time consuming, stressful, disruptive to the passenger, and increase risk of injury to the passenger. Further, a personal or specialized wheelchair must be stowed on-board the aircraft between uses of the wheelchair. Stowage solutions in the passenger cabin are limited and therefore require the wheelchair to fold. Having to fold, stow, retrieve, and ready a wheelchair for usage increases the time to disembark passengers and consequently the turnover time of the aircraft between flights. In addition, an aircraft passenger seat may be incapable of functioning comparatively to a personal or specialized wheelchair.

Accordingly, what is needed is an on-board solution for accommodating wheelchair-dependent passengers that obviates the need for transfer chairs, passenger transfers, specialized passenger seats, etc.

### BRIEF SUMMARY

According to a first aspect, the present disclosure provides a layout for a passenger cabin such as an aircraft passenger cabin. The layout includes a longitudinal aisle such as an aisle parallel to an aircraft longitudinal axis, and a first branch aisle extending from the longitudinal aisle. A door is positioned at one end of the branch aisle opposite the longitudinal aisle. A closet is positioned to one side of the first branch aisle and includes a first compartment extending between a first wall and a second wall and from a floor to a ceiling formed in the first compartment, the first compartment enterable from the first branch aisle, and the first compartment dimensioned to accommodate a wheelchair in an unfolded condition, and a second compartment positioned to one side of the first compartment.

In some embodiments, the second compartment is positioned between the first compartment and a wall adjacent the door, such as a fuselage wall of the aircraft, and the second compartment is accessible from the first branch aisle.

In some embodiments, the second compartment is positioned between the first compartment and the longitudinal aisle, and the second compartment is accessible from at least one of the first branch aisle and the longitudinal aisle.

In some embodiments, the layout further includes at least one passenger seat, such as a seat row, positioned on a side of the closet opposite the first branch aisle, and a second branch aisle positioned between the at least one passenger seat and the closet, the second branch aisle extending from the longitudinal aisle, wherein the first compartment is enterable from the second branch aisle.

In some embodiments, the closet includes a third compartment positioned directly above the second branch aisle, wherein the third compartment is accessible from at least one of the first compartment, the second branch aisle, and the longitudinal aisle, and wherein a bottom of the third compartment is substantially no lower than a height of the ceiling formed in the first compartment.

In some embodiments, the first compartment is enterable from the second branch aisle.

In some embodiments, the closet includes at least one of oxygen equipment and medical equipment located above the ceiling formed in the first compartment, the at least one of the oxygen equipment and the medical equipment configured for use by a passenger in the wheelchair accommodated in the first compartment.

In some embodiments, the closet includes a pallet positioned on the floor of the first compartment, the pallet including at least one device for attaching a strap to secure the wheelchair in place on the pallet.

In some embodiments, the pallet is configured to be secured to seat tracks in the floor and positioned at an angle to the longitudinal aisle.

In some embodiments, the first compartment is enterable through an opening without a door.

According to another aspect, the present disclosure provides a closet positionable in an aircraft to one side of a longitudinal aisle and to one side of a first branch aisle extending from the longitudinal aisle to a door of the aircraft. The closet includes a first compartment extending between a first wall and a second wall and from a floor to a ceiling formed in the first compartment, the first compartment enterable from the first branch aisle, and the first compartment dimensioned to accommodate a wheelchair in an unfolded condition, and a second compartment positioned to one side of the first compartment.

In some embodiments, the closet is further positionable to one side of a second branch aisle positioned forward of at least one passenger seat, and the first compartment is enterable from the second branch aisle.

In some embodiments, the closet further comprises a third compartment positioned directly above the second branch aisle, the third compartment being accessible from at least one of the first compartment, the second branch aisle, and the longitudinal aisle, and a bottom of the third compartment positioned substantially no lower than a height of the ceiling formed in the first compartment.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the disclosure are disclosed in the following detailed description and the accompanying drawings. The drawings are not necessarily to scale. In general, operations of disclosed processes may be performed in an arbitrary order, unless otherwise provided in the claims. In the drawings:

FIG. 1 illustrates a portion of an aircraft passenger cabin including a closet configured to accommodate a wheelchair in an aft facing direction, in accordance with at least one embodiment of the present disclosure;

FIG. 2 illustrates a portion of an aircraft passenger cabin including a closet configured to accommodate a wheelchair in a forward facing direction, in accordance with at least one embodiment of the present disclosure;

FIG. 3 illustrates a closet configuration according to an embodiment of the present disclosure, showing a wheelchair secured in a compartment formed in the closet, in accordance with at least one embodiment of the present disclosure;

FIG. 4 illustrates a ceiling portion of the closet shown in FIG. 3, configured for locating oxygen equipment, medical equipment, other emergency equipment etc., in accordance with at least one embodiment of the present disclosure;

FIG. 5 illustrates compartment space formed by a closet configuration, in accordance with at least one embodiment of the present disclosure;

FIG. 6 illustrates a palletized wheelchair securement location in an aft facing direction, in accordance with at least one embodiment of the present disclosure;

FIG. 7 illustrates a palletized wheelchair securement location in a forward facing direction, in accordance with at least one embodiment of the present disclosure;

FIG. 8 illustrates a further palletized wheelchair securement location in a forward facing direction, in accordance with at least one embodiment of the present disclosure;

FIG. 9 illustrates a further palletized wheelchair securement location in an aft facing direction, in accordance with at least one embodiment of the present disclosure; and

FIG. 10 illustrates compartment volumes affording according to implementation of a closet configuration, in accordance with at least one embodiment of the present disclosure.

### DETAILED DESCRIPTION

Before explaining embodiments of the inventive concepts disclosed herein in detail, it is to be understood that the inventive concepts disclosed herein are not limited in their application to the details of construction and the arrangement of the components or steps or methodologies set forth in the following description or illustrated in the drawings. In the following detailed description of embodiments of the present disclosure, numerous specific details are set forth in order to provide a more thorough understanding of the inventive concepts. However, it will be apparent to one of ordinary skill in the art having the benefit of the present disclosure that the inventive concepts disclosed herein may be practiced without these specific details. In other instances, well-known features may not be described in detail to avoid unnecessarily complicating the present disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein, where applicable, a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). In addition, use of the “a” or “an” are employed to describe elements and components of embodiments of the present inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination or sub-combination of two or more such features, along with any other features which may not necessarily be expressly described or inherently present in the present disclosure.

Broadly, the present disclosure provides closet configurations for accommodating an unfolded wheelchair in a passenger cabin, for instance an aircraft passenger cabin. As used herein, the term “closet” refers to any enclosure, cabinet, monument or other furniture typically used for the purpose of stowing items in a passenger cabin, for instance an aircraft passenger cabin. Preferably, but not necessarily, a wheelchair according to the present disclosure means a passenger provided wheelchair and not an airport or airline carrier provided wheelchair configured for passenger transfer to and from a conventional passenger seat. In some embodiments, the wheelchair may be a standard sized or specialized wheelchair having a width or other dimension that makes the wheelchair incapable of traversing a conventional longitudinal aisle width. As used herein, the term “passenger of restricted mobility” is intended to mean any passenger that requires and/or benefits from the full-time or part-time use of a wheelchair. A wheelchair according to the present disclosure may be specialized in order to accommodate specific needs of the passenger.

Regarding implementation, a closet according to the present disclosure is preferably positioned proximate an exterior door of the conveyance, such as an aircraft door for entering and exiting an aircraft. As used herein, aisle means any passageway in the cabin. The passenger cabin may include at least one longitudinal aisle arranged substantially parallel to an aircraft longitudinal aisle. Branch aisles may extend from the longitudinal aisle. For example, a branch aisle may be arranged perpendicular to a longitudinal aisle providing a passageway between an exit door and a longitudinal aisle. A closet may be positioned along a branch aisle such to one side of a branch aisle, such that the closet is directly accessible from the branch aisle upon entering into the aircraft.

The flight direction of the aircraft is indicated in the figures by the directional arrow 10 to provide meaning and context for forward and aft descriptions as used herein. For example, forward as used herein means generally facing the direction of flight, albeit in some embodiments angled and not necessary parallel to the aircraft longitudinal axis. As used herein, forward may also means a position closer to a front of the aircraft as compared to a referenced object. Vice versa, as used herein, aft means generally facing opposite the direction of flight, also in some embodiments at an angle to the aircraft longitudinal axis, as well as closer to a back of the aircraft as compared to a referenced object.

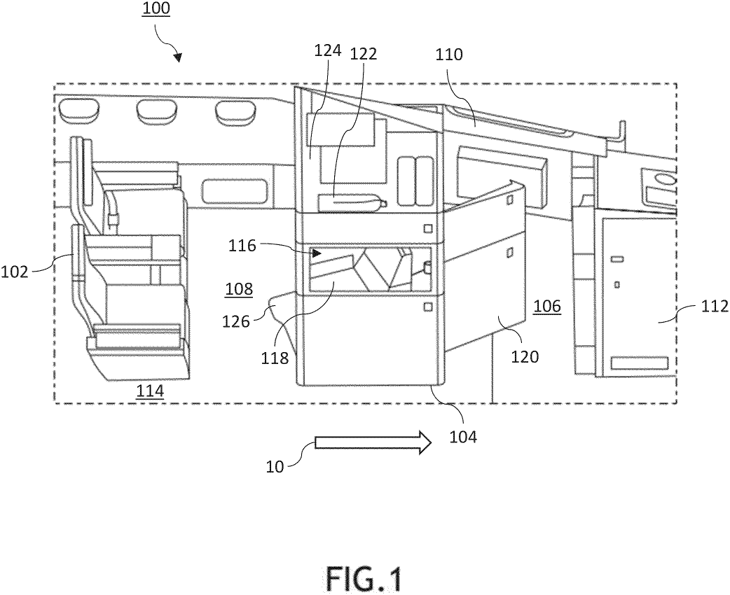

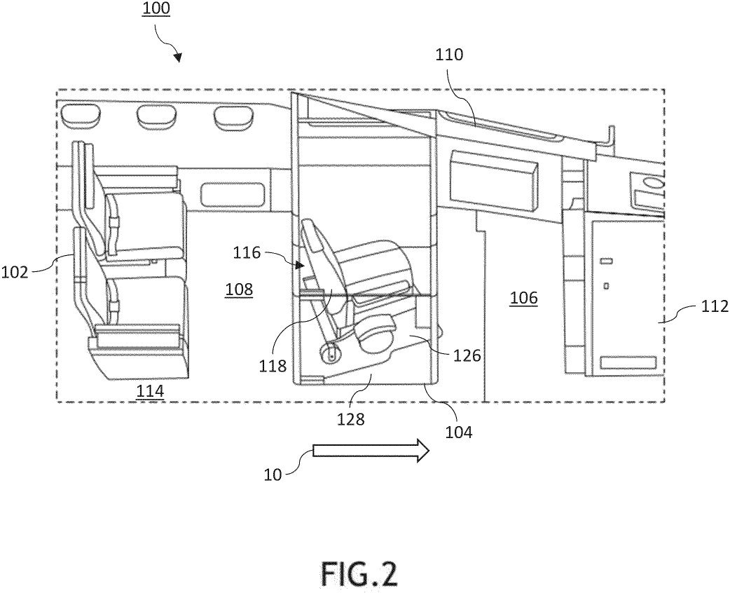

Referring to FIGS. 1 and 2, a non-limiting example of a portion of an aircraft cabin is shown generally at 100. The portion shown includes a seat row 102, a closet 104, a first branch aisle 106 positioned forward of the closet 104, and a second branch aisle 108 positioned between the first seat row 104 and the closet 104. In some embodiments, the first branch aisle 106 extends from an exterior door 110 for entering and exiting the aircraft, for instance during embarking and disembarking. In some embodiments, a lavatory 112 may be positioned to one side first branch aisle 106 and opposite the closet 104. The lavatory 112 may have a door that opens directly to the first branch aisle 106 such that a substantially straight passageway is provided between the first compartment of the closet 104 and the lavatory 112, as discussed further below. The lavatory 112 may include an aisle side door in addition to a branch aisle door, wherein the branch aisle door is dimensioned to allow passage of a wheelchair. In other embodiments, a galley may be positioned where the lavatory is shown or another closet 104.

The cabin layout 100 further includes at least one longitudinal aisle 114 arranged parallel to the aircraft longitudinal axis. In some embodiments, the longitudinal aisle 114 extends substantially the length of the aircraft. Each of the first and second branch aisles 106, 108 extend from the longitudinal aisle 114 to the fuselage wall. Upon entering the cabin through the exterior door 110, passengers with seat assignments traverse the first branch aisle 106 to reach the longitudinal aisle 114, and thereafter traverse the longitudinal aisle 114 to reach their assigned seat. The first branch aisle 106 has a width sufficient to accommodate a wheelchair and provides direct access into the first compartment formed in the closet 104, as discussed further below. The second branch aisle 108 may have a similar width as compared to the first branch aisle 106 in embodiments in which a wheelchair enters into the first compartment from the second branch aisle 108. The longitudinal aisle 114, at least the portion extending between the first branch aisle 106 and the second branch aisle 108 may have a width to allow passage of a wheelchair. In some embodiments, the first compartment formed in the closet 104 is enterable from the second branch aisle 108 and the seat row 102 facing the closet 104 is reserved for caretakers, family members or traveling companions of the person with restricted mobility, i.e., a relationship between the passenger(s) in the seat row and the passenger in the first compartment formed in the closet 104.

The closet 104 includes a first compartment 116 and at least one second compartment. The first compartment 116 is dimensioned to accommodate a wheelchair 118, preferably in an unfolded condition and in some cases occupied by person with restricted mobility. Referring to FIG. 1, in some embodiments, a door 120 provides access into the first compartment 118 from the first branch aisle 106. Equipment 122, such as oxygen equipment, medical equipment, and other equipment may be located in the ceiling 124 directly above the first compartment. In some embodiments, the equipment 122 is intended for use by the person with restricted mobility as needed and/or in the event of an emergency situation. As shown, the wheelchair 118 is secured in place on a pallet 126 and is oriented facing the aft direction, generally facing the seat row 102, and angled relative to the longitudinal aisle 114. Referring to FIG. 2, the wheelchair 118 is also shown positioned in the first compartment 116 and secured in place on a pallet 126, but instead facing the forward direction and angled toward the exterior door 110. FIG. 2 further shows the first compartment 116 positioned behind an interior wall 128 adjacent the longitudinal aisle 114. The positioning of the wheelchair 118 in the forward or aft facing direction may be according to the preference of the passenger, positioning capability of the first compartment 116 and/or floor pallet 126, and location of a caretaker relative to the passenger.

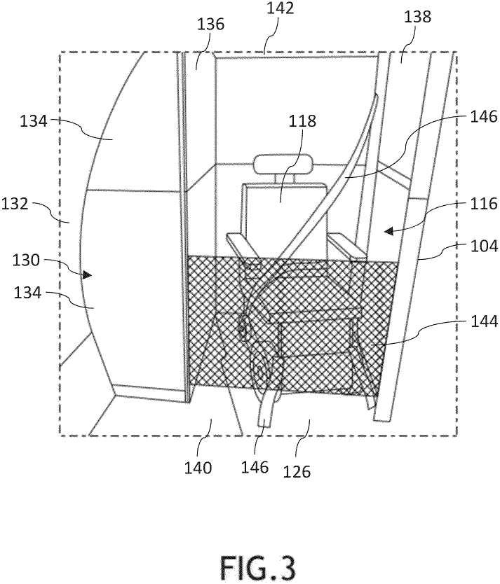

Referring to FIG. 3, the closet 104 generally includes the first compartment 116 and at least one second compartment 130 positioned adjacent to the first compartment 116. As shown, the at least one second compartment 130 may be positioned to one side of the first compartment 116, for instance between the first compartment 116 and the fuselage 132. The at least one second compartment 130 may include a lower compartment and an upper compartment each including a door 134 for accessing the interior space. The at least one second compartment 130 may or may not be reserved for use the passenger in the first compartment 116.

The first compartment 116 is formed between a first wall 136 and a second wall 138 and extends from the floor 140 to the ceiling 142. The pallet 126 is secured to the floor 140, such as to seat tracks embedded in the floor 140. The first compartment 116 may be open at one end, for instance the end proximate the first branch aisle or the end proximate of the second branch aisle. In some embodiments, both compartment ends may be open forming a passageway through the first compartment 116, such as a passageway between branch aisles. Cargo netting 144 or the like may be used, for example during taxi, takeoff and landing, to close the entrance to the compartment. Securement straps 146 may be used to secure the wheelchair 118 in place on the pallet 126. In some embodiments, the straps 146 anchor at one end to the closet 104 or to the pallet 126, and anchor at their opposing end to the other of the closet 104 or the pallet 126, or to the wheelchair 118 itself. As shown in FIG. 3, when implemented in an aircraft passenger cabin the closet 104 shape may correspond to the curvature of the fuselage.

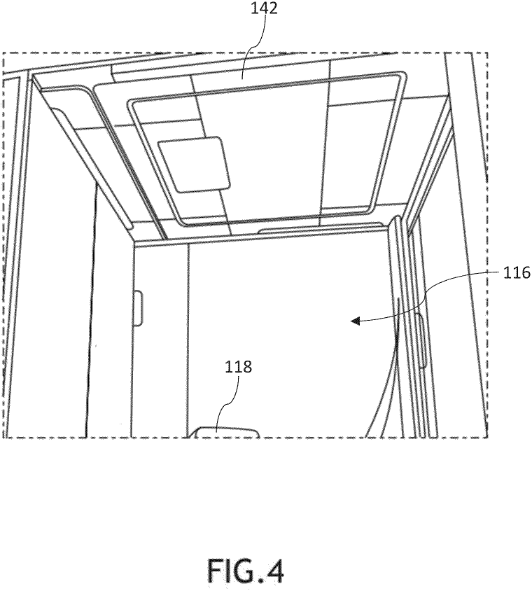

Referring to FIG. 4, the compartment ceiling 142 serves as the location for equipment, such as emergency oxygen equipment (see FIG. 1 at 122) for use by the passenger in the first compartment 116. Although not shown, additional amenities may be provided in the first compartment, such as a deployable tray table, media equipment, lighting, climatization, etc.

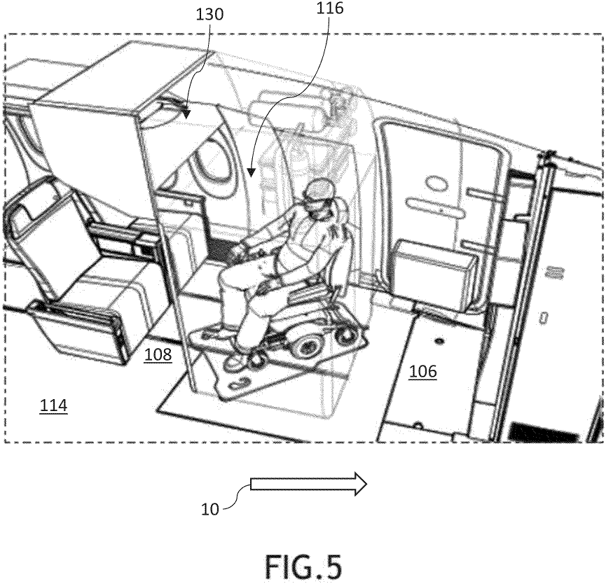

Referring to FIG. 5, another configuration for the closet 104 includes the first compartment 116 and the at least one second compartment 130 positioned to one end of the closet 104. As shown, the second compartment 130 is positioned at the aft end of the first compartment and elevated above the floor. More particularly, the second compartment 130 is positioned directly over the second branch aisle 108. The first compartment 116 may be enterable from one or both of the first branch aisle 106 and the second branch aisle 108. In this configuration, the first compartment 116 may extend substantially the length of the closet 104, i.e., from the fuselage wall to the interior wall adjacent the longitudinal aisle 114, and the second compartment 130 may also extend substantially from the fuselage wall to the longitudinal aisle 114. The second compartment 130 may or may not be reserved for use by the passenger in the first compartment 116. The second compartment 130 may be accessible from one or more of the first compartment 116, second branch aisle 108, and longitudinal aisle 114.

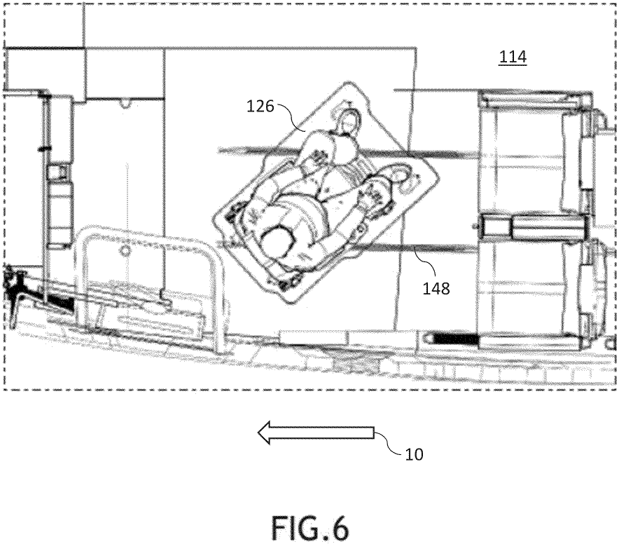

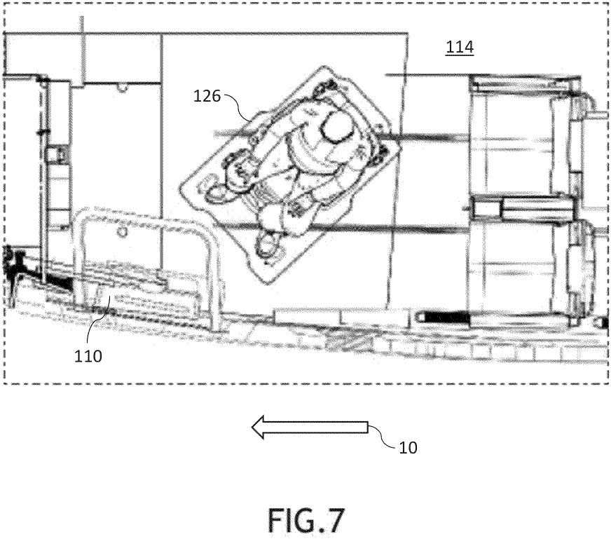

Referring to FIG. 6, wherein the closet is removed for clarity, a first pallet 126 orientation is shown generally aft facing and angled relative to the longitudinal aisle 114. The pallet 126 may be secured to seat tracks 148 embedded in the floor. In some embodiments, the pallet 126 may be positionally fixed. In other embodiments, the position of the pallet 126 may be adjustable based on passenger preference. Referring to FIG. 7, wherein the closet is removed for clarity, a second possible pallet 126 orientation is shown generally forward facing, angled away from the longitudinal aisle 114, and angled toward the exit door 110. The pallet 126 positions shown in FIGS. 6 and 7 may be better suited for use with the longitudinally shifted and elevated second compartment closet configuration shown in FIG. 5.

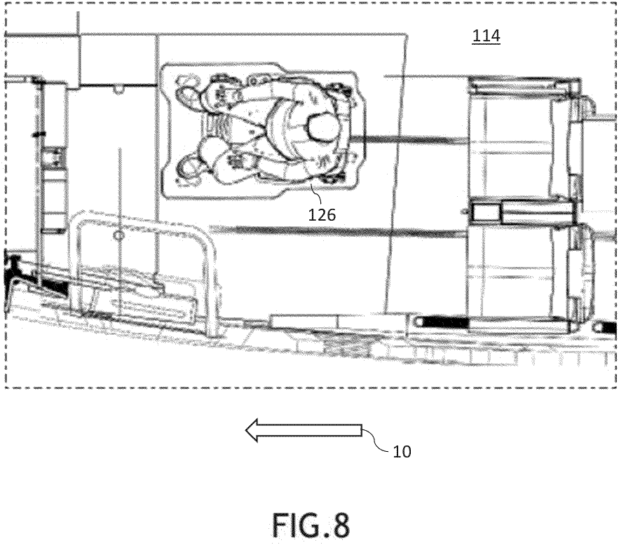

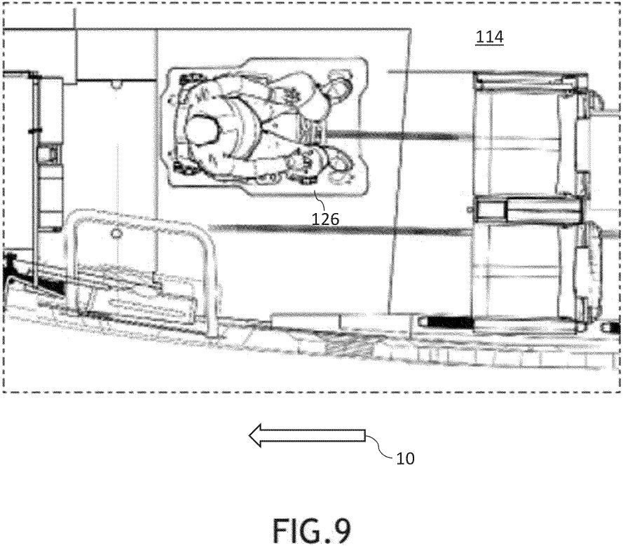

Referring to FIG. 8, wherein the closet is removed for clarity, the pallet 126 is positioned forward facing and parallel to the longitudinal aisle 114. Referring to FIG. 9, wherein the closet is removed for clarity, the pallet 126 is shown positioned aft facing and parallel to the longitudinal aisle 114. The pallet 126 positions shown in FIGS. 8 and 9 may be better suited for use with laterally positioned second compartments wherein a portion of the closet width is consumed by each of the first compartment and the at least one second compartment.

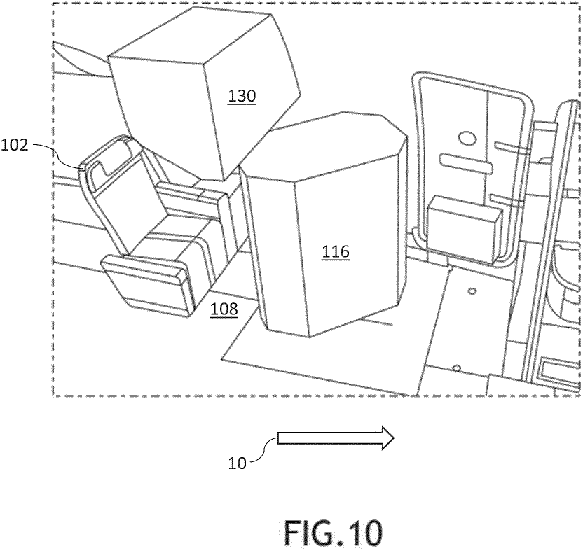

Referring to FIG. 10, the comparative volumes and positional relationship of the first compartment 116 and longitudinally-shifted second compartment 130 are shown. The storage volume lost by adding the first compartment 116 may be moved to the second compartment 130, such as a bustle, positioned adjacent and aft of the first compartment 116 and above the second branch aisle 108 and at least a portion of the seat row 102. In some embodiments, the second compartment 130 may include nearly 50% of the lost storage volume. Therefore, if a partition across the aisle incorporates a similar second compartment, then the storage volume may be 100% recovered. The embodiments according to the present disclosure are advantageous in that the closet may increase in space, e.g., length, and the lost storage volume can be made up by re-pitching the seats on the side of the aircraft where the closet is located.

Wheelchair attachment structure may include one or more straps configured to fasten the wheelchair to the pallet 126. The straps may include one or more locking or latching mechanisms configured to secure the wheelchair to the pallet 126. The attachment structure may be configured to rotate or swivel and enable a user of the wheelchair to face any direction (e.g., 360° of freedom), thereby potentially reducing motion sickness for a user of the wheelchair. The first compartment 116 is formed by the one or more walls which may include a window.

While the foregoing description provides embodiments of the invention by way of example only, it is envisioned that other embodiments may perform similar functions and/or achieve similar results. Any and all such equivalent embodiments and examples are within the scope of the present invention and are intended to be covered by the appended claims.

What is claimed:

1. A passenger cabin layout, comprising:
a longitudinal aisle;
a first branch aisle extending from the longitudinal aisle;
a door positioned at one end of the branch aisle opposite the longitudinal aisle; and
a closet positioned to one side of the first branch aisle, the closet comprising:
a first compartment extending between a first wall and a second wall and from a floor to a ceiling formed in the first compartment, the first compartment enterable from the first branch aisle, and the first compartment dimensioned to accommodate a wheelchair in an unfolded condition; and
a second compartment positioned to one side of the first compartment.

2. The passenger cabin layout according to claim 1, wherein:
the second compartment is positioned between the first compartment and a wall adjacent the door; and
the second compartment is accessible from the first branch aisle.

3. The passenger cabin payout according to claim 1, wherein:
the second compartment is positioned between the first compartment and the longitudinal aisle; and
the second compartment is accessible from at least one of the first branch aisle and the longitudinal aisle.

4. The passenger cabin layout according to claim 1, further comprising:
at least one passenger seat positioned on a side of the closet opposite the first branch aisle; and
a second branch aisle positioned between the at least one passenger seat and the closet, the second branch aisle extending from the longitudinal aisle;
wherein the first compartment is enterable from the second branch aisle.

5. The passenger cabin layout according to claim 4, wherein:
the closet further comprises a third compartment positioned directly above the second branch aisle;
the third compartment is accessible from at least one of the first compartment, the second branch aisle, and the longitudinal aisle; and
a bottom of the third compartment is no lower than a height of the ceiling formed in the first compartment.

6. The passenger cabin layout according to claim 4, wherein the first compartment is enterable from the second branch aisle.

7. The passenger cabin layout according to claim 1, further comprising at least one of oxygen equipment and medical equipment located above the ceiling formed in the first compartment, the at least one of the oxygen equipment and the medical equipment configured for use by a passenger in the wheelchair accommodated in the first compartment.

8. The passenger cabin layout according to claim 1, further comprising a pallet positioned on the floor of the first compartment, the pallet including at least one device for attaching a strap to secure the wheelchair in place on the pallet.

9. The passenger cabin layout according to claim 1, wherein the pallet is configured to be secured to seat tracks in the floor and positioned at an angle to the longitudinal aisle.

10. The passenger cabin layout according to claim 1, wherein the first compartment is enterable through an opening without a door.

11. A closet positionable in an aircraft to one side of a longitudinal aisle and to one side of a first branch aisle extending from the longitudinal aisle to a door of the aircraft, the closet comprising:
a first compartment extending between a first wall and a second wall and from a floor to a ceiling formed in the first compartment, the first compartment enterable from the first branch aisle, and the first compartment dimensioned to accommodate a wheelchair in an unfolded condition; and
a second compartment positioned to one side of the first compartment.

12. The closet according to claim 11, wherein:
the closet is further positionable to one side of a second branch aisle positioned forward of at least one passenger seat; and
the first compartment is enterable from the second branch aisle.

13. The closet according to claim 12, wherein:
the closet further comprises a third compartment positioned directly above the second branch aisle;
the third compartment is accessible from at least one of the first compartment, the second branch aisle, and the longitudinal aisle; and
a bottom of the third compartment is no lower than a height of the ceiling formed in the first compartment.

14. The closet according to claim 11, further comprising at least one of oxygen equipment and medical equipment located above the ceiling formed in the first compartment, the at least one of the oxygen equipment and the medical equipment configured for use by a passenger in the wheelchair accommodated in the first compartment.

15. The closet according to claim 11, further comprising a pallet positioned on the floor of the first compartment, the pallet including at least one device for attaching a strap to secure the wheelchair in place on the pallet.
